(19) United States
(12) Patent Application Publication
(10) Pub. No.: US 2016/0236425 A1
(43) Pub. Date: Aug. 18, 2016

(54) ROUGHENED TOOL SURFACES FOR THERMOSET COMPOSITE LAYUPS AND SYSTEMS AND METHODS INCLUDING THE SAME

(71) Applicant: The Boeing Company, Huntington Beach, CA (US)

(72) Inventors: Kieran Patrick Davis, Seattle, WA (US); Stephen Lee Metschan, Black Diamond, WA (US); Richard V. Phillips, Enumclaw, WA (US); Jeff Ray Maher Longcore, Kirkland, WA (US)

(73) Assignee: The Boeing Company, Huntington Beach, CA (US)

(21) Appl. No.: 14/621,843

(22) Filed: Feb. 13, 2015

(51) Int. Cl. B29C 70/34; B29C 70/30

(52) U.S. Cl. CPC B29C 70/34; B29C 70/30; B29L 2031/3076

(57) ABSTRACT

Roughened tool surfaces for thermoset composite layups and systems and methods including the same are disclosed herein. The systems include a first tool that includes a first tool body that defines the roughened tool surface and a second tool that defines a second tool surface. The roughened tool surface is shaped to receive and to form a plurality of plies of composite thermoset composite material, which defines a thermoset composite layup. A roughness of the roughened tool surface is within a predefined roughness range. The second tool surface is configured to receive a plurality of discrete thermoset composite layups and to be heated with the plurality of discrete thermoset composite layups to cure the plurality of discrete thermoset composite layups and define a thermoset composite structure. The methods include methods of forming the thermoset composite structure utilizing the first tool and the second tool.

### FIELD

The present disclosure relates to roughened tool surfaces for thermoset composite layups, to systems that include the roughened tool surface, and/or to methods that utilize the roughened tool surfaces.

### BACKGROUND

Tool surfaces, such as layup mandrel surfaces, often may be utilized to support thermoset composite layups during formation thereof. These thermoset composite layups generally include a plurality of layers of pre-impregnated (pre-preg) material that are progressively built up on the tool surface. Generally, the plurality of layers of pre-preg is compacted on the tool surface to remove void space between individual layers, to bring adjacent layers into contact with one another, to conform the thermoset composite layup to a shape of the tool surface, and/or to adhere the adjacent layers to one another. Subsequently, the thermoset composite layup may be heated, while still being supported by the tool surface, to cure the thermoset composite layup. The cured thermoset composite layup then may be removed from the tool surface to produce a cured composite part, which may be in final form and/or may receive additional processing prior to producing a final composite part.

Under certain circumstances, it may be desirable to remove the thermoset composite layup from the tool surface prior to curing the thermoset composite layup. However, this removal may be difficult without damaging the thermoset composite layup. As an example, adhesive forces between the thermoset composite layup and the tool surface may cause deformation of the thermoset composite layup during removal from the tool surface, and this deformation may produce undesirable buckling, wrinkling, layer-layer shifting, and/or other distortion of the thermoset composite layup. Thus, there exists a need for roughened tool surfaces for thermoset composite layups and/or for systems and methods that include and/or utilize the roughened tool surfaces.

### SUMMARY

Roughened tool surfaces for thermoset composite layups and systems and methods including the same are disclosed herein. The systems include a first tool that includes a first tool body that defines the roughened tool surface and a second tool that defines a second tool surface. The roughened tool surface is shaped to receive and to form a plurality of plies of thermoset composite material. The plurality of plies of thermoset composite material defines a thermoset composite layup. A roughness of the roughened tool surface is within a predefined roughness range. The second tool surface is configured to receive a plurality of discrete thermoset composite layups and to be heated with the plurality of discrete thermoset composite layups to cure the plurality of discrete thermoset composite layups and define a thermoset composite structure. The plurality of discrete thermoset composite layups includes the thermoset composite layup that is defined with, and has been removed from, the first tool.

The methods include methods of forming the thermoset composite structure. The methods include locating an initial layer of material on a roughened tool surface of a first tool. The roughened tool surface includes a plurality of perforations that is configured to provide fluid communication between the roughened tool surface and a fluid manifold. The method further includes applying a retention vacuum to the fluid manifold to retain the initial layer of material on the roughened tool surface and locating a plurality of plies of thermoset composite material on the initial layer of material to define a thermoset composite layup. The method also includes releasing the retention vacuum and removing the thermoset composite layup from the roughened tool surface of the first tool. The method further includes locating the thermoset composite layup on a second tool surface of a second tool and heating the second tool and the thermoset composite layup to cure the thermoset composite layup and define the thermoset composite structure.

### BRIEF DESCRIPTION OF THE DRAWINGS

FIG. 1 is an example of an aircraft that includes a thermoset composite structure that may be formed using the systems and methods according to the present disclosure.

FIG. 2 is an example of a fuselage barrel that may form a portion of the aircraft of FIG. 1.

FIG. 3 is a schematic view of a tool, according to the present disclosure, for receiving and forming a thermoset composite layup.

FIG. 4 is a schematic cross-sectional view of the tool of FIG. 3.

FIG. 5 is a schematic view of a system, according to the present disclosure, for forming a thermoset composite structure.

FIG. 6 is a flowchart depicting a method, according to the present disclosure, of forming a roughened tool surface on a tool body of a tool for receiving and forming a thermoset composite layup.

FIG. 7 is a flowchart depicting methods, according to the present disclosure, of forming a thermoset composite structure.

FIG. 8 is a flow diagram of aircraft production and service methodology.

FIG. 9 is a block diagram of an aircraft.

### DESCRIPTION

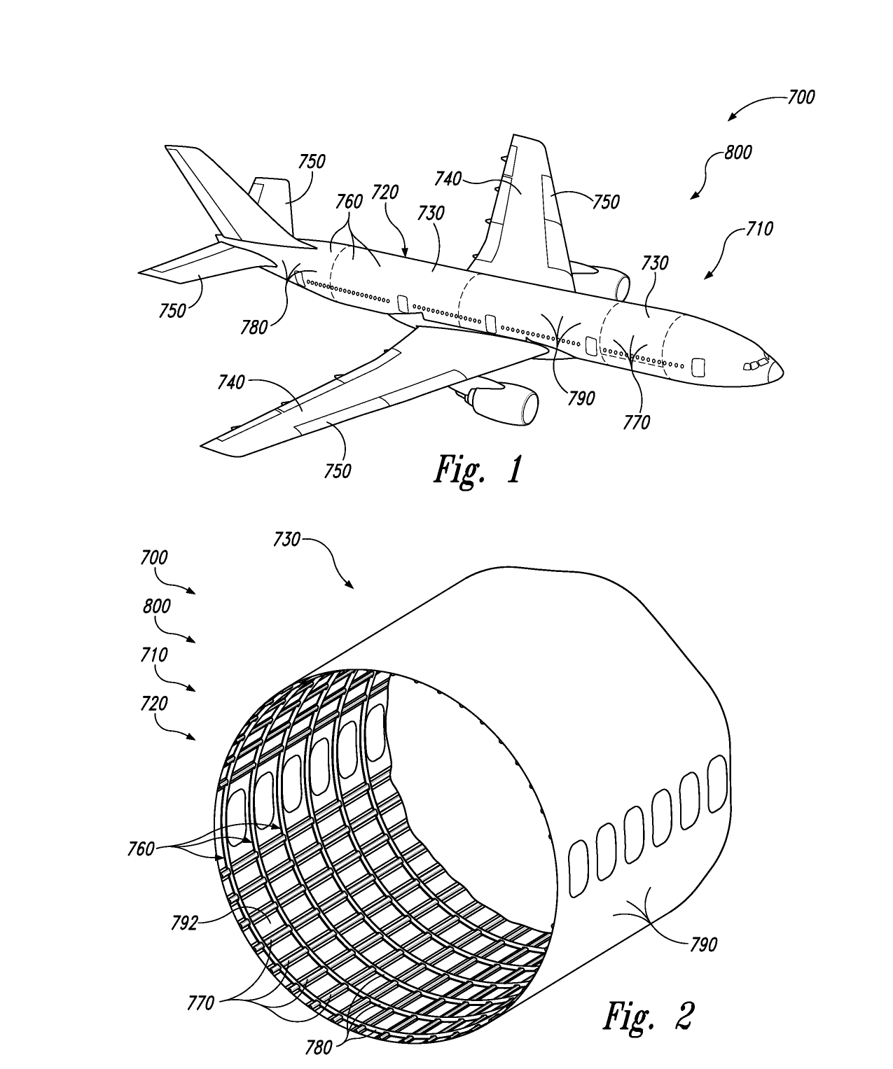

FIGS. 1-9 provide examples of tools 100, according to the present disclosure, for receiving and forming a thermoset composite structure 800, of systems that may include and/or utilize tools 100, of methods 200, according to the present disclosure, of forming tools 100, and/or of methods 300, according to the present disclosure, of forming thermoset composite structures 800. Elements that serve a similar, or at least substantially similar, purpose are labeled with like numbers in each of FIGS. 1-9, and these elements may not be discussed in detail herein with reference to each of FIGS. 1-9. Similarly, all elements may not be labeled in each of FIGS. 1-9, but reference numerals associated therewith may be utilized herein for consistency. Elements, components, and/or features that are discussed herein with reference to one or more of FIGS. 1-9 may be included in and/or utilized with any of FIGS. 1-9 without departing from the scope of the present disclosure.

In general, elements that are likely to be included in a given (i.e., a particular) embodiment are illustrated in solid lines, while elements that are optional to a given embodiment are illustrated in dashed lines. However, elements that are shown in solid lines are not essential to all embodiments, and an element shown in solid lines may be omitted from a given embodiment without departing from the scope of the present disclosure.

FIG. 1 is an illustrative, non-exclusive example of an aircraft 700 that includes a thermoset composite structure 800. Thermoset composite structure 800 may be constructed utilizing system 20, tool 100, and/or method 300, according to the present disclosure. FIG. 2 is an illustrative, non-exclusive example of a fuselage barrel 730 that may form a portion of aircraft 700 and includes thermoset composite structure 800. Aircraft 700 and/or thermoset composite structure 800 thereof may include a plurality of skin segments 790 that may form, cover, and/or be an outer surface of any suitable portion of aircraft 700. As illustrated most clearly in FIG. 2, aircraft 700 also may include a plurality of stringers 770 that, together with a plurality of frames 780, may support an inner surface 792 of skin segments 790. A plurality of fillers 760 may extend between frames 780 and inner surface 792 and may form a portion of thermoset composite structure 800. Skin segments 790, stringers 770, frames 780, and/or fillers 760 may be constructed utilizing system 20, tool 100, and/or method 300, according to the present disclosure.

It is within the scope of the present disclosure that any suitable portion of aircraft 700 may be formed from and/or may be thermoset composite structure 800. As illustrative, non-exclusive examples, thermoset composite structure 800 may form, or form a portion of, an airframe 710, a fuselage 720, a fuselage barrel 730, a wing 740, and/or a stabilizer 750 of aircraft 700.

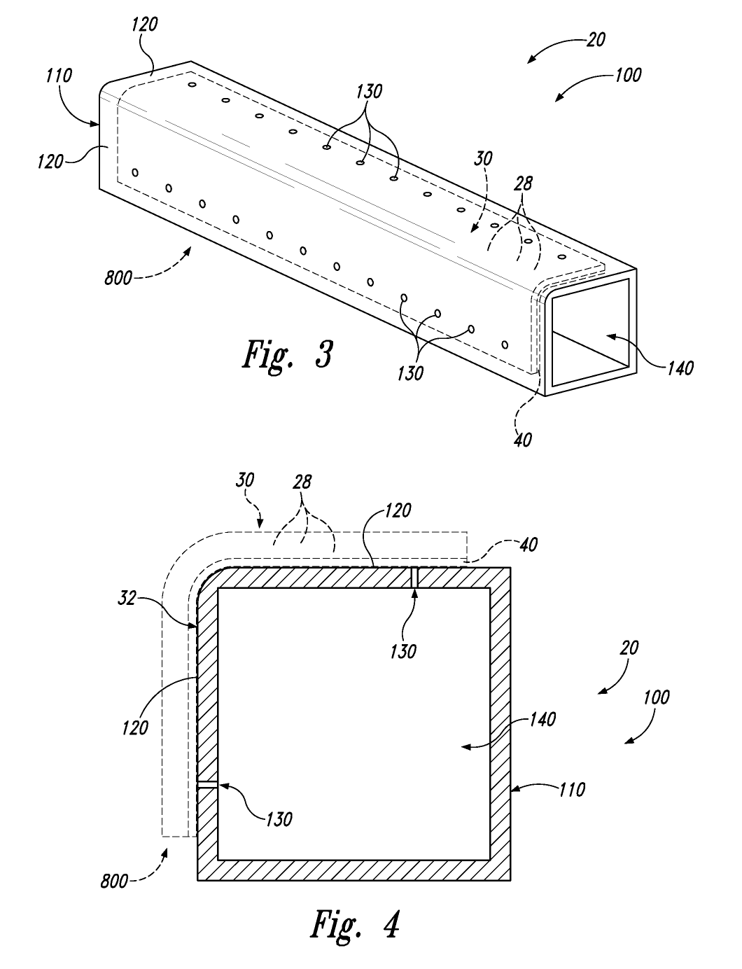

FIG. 3 is a schematic view of a tool 100, according to the present disclosure, for receiving and forming a thermoset composite layup 30, while FIG. 4 is a schematic cross-sectional view of tool 100 of FIG. 3. Tool 100 includes a tool body 110 that includes, defines, and/or has at least one roughened tool surface 120. Roughened tool surface 120 is adapted, configured, designed, sized, and/or shaped to receive and to form a plurality of plies 28 of thermoset composite material that may define a thermoset composite layup 30.

Roughened tool surface 120 has a roughness that is within a predefined, preselected, and/or prescribed roughness range, and this roughness of roughened tool surface 120 may permit and/or facilitate utilization of tool 100, location of plies 28 on roughened tool surface 120, formation of thermoset composite layup 30 on roughened tool surface 120, and/or subsequent removal of thermoset composite layup 30 from roughened tool surface 120. As an example, and as illustrated, tool body 110 and/or roughened tool surface 120 thereof may include and/or define a plurality of perforations 130 that may be configured to provide fluid communication between roughened tool surface 120 and a fluid manifold 140 that is in fluid communication with the plurality of perforations. As illustrated in FIGS. 3-4, fluid manifold 140 may be at least partially, or even completely, defined by tool body 110; however, this is not required in all embodiments.

During formation of thermoset composite layup 30, a retention vacuum may be applied to an interface 32 (as illustrated in FIG. 4) between an initial layer 40 of material that extends across roughened tool surface 120. Subsequently plies 28 may be located on initial layer 40 to form thermoset composite layup 30. The retention vacuum may retain initial layer 40 on roughened tool surface 120 and/or resist motion of initial layer 40 during formation of thermoset composite layup 30. Additionally or alternatively, and subsequent to formation of thermoset composite layup 30, a fluid pressure may be applied to interface 32 via perforations 130 and fluid manifold 140. This fluid pressure may generate a motive force for separation of initial layer 40 from roughened tool surface 120, which may permit and/or facilitate removal of thermoset composite layup 30 from roughened tool surface 120.

More conventional tools that may be utilized to form a conventional thermoset composite layup and that retain the conventional thermoset composite layup thereon during curing of the conventional thermoset composite layup to form a conventional thermoset composite structure generally include a smooth, or at least substantially smooth, tool surface. When compared to these conventional tools, the presence of roughened tool surface 120 on tools 100 according to the present disclosure may permit, facilitate, and/or improve fluid flow at interface 32.

This improved fluid flow may increase a retention force that may retain initial layer 40 on roughened tool surface 120 during application of the retention vacuum, may decrease an occurrence of regions of interface 32 where the retention vacuum is not applied (or does not propagate from perforations 130), and/or may decrease an average spacing between perforations 130 that may be needed to produce a desired level of vacuum, or vacuum uniformity, at interface 32. This also may aid in removal of thermoset composite layup from roughened tool surface 120 via the improved fluid flow to interface 32 during application of the fluid pressure, via a decrease in an actual area of contact between initial layer 40 and roughened tool surface 120, and/or via a decrease in electrostatic forces that may serve to retain initial layer 40 in contact with roughened tool surface 120 subsequent to formation of thermoset composite layup 30.

As discussed, tools 100 according to the present disclosure include tool body 110 that includes and/or defines roughened tool surface 120. As also discussed, roughened tool surface 120 generally has a roughness that is within a predefined roughness range. This predefined roughness range may be based upon any suitable criteria. As examples, the predefined roughness range may be based, at least in part, on a modulus of elasticity of initial layer 40, on a modulus of elasticity of plies 28, and/or on a desired spacing between perforations 130.

In general, a force needed to remove thermoset composite layup 30 from roughened tool surface 120 decreases with increasing roughness of roughened tool surface 120. For very smooth surfaces and/or for roughened tool surfaces 120 that exhibit less than a threshold roughness, the force needed to remove thermoset composite layup 30 from roughened tool surface 120 may be (relatively) large. As the roughness of roughened tool surface 120 is increased, the force decreases substantially. However, a maximum practical value for the roughness may be selected based upon manufacturing specifications regarding a desired overall smoothness of thermoset composite layup 30 and/or of thermoset composite structure 800 that may be formed therefrom.

With this in mind, the predefined roughness range may extend between a minimum roughness and a maximum roughness (or the roughness may have a value that is defined between the minimum roughness and the maximum roughness). The minimum roughness and/or the maximum roughness may be selected, defined, and/or quantified based upon any suitable criteria. As an example, the minimum roughness and/or the maximum roughness may be quantified as an average peak-to-valley height, Rz, which may be defined by and/or measured utilizing ASME Y14.36M-1996.

As examples, the minimum roughness may have an average peak-to-valley height, Rz, of 5 micrometers, 6 micrometers, 7 micrometers, 8 micrometers, 9 micrometers, 10 micrometers, 11 micrometers, 12 micrometers, 13 micrometers, 14 micrometers, 15 micrometers, 16 micrometers, 17 micrometers, 18 micrometers, 19 micrometers, or 20 micrometers. Additionally or alternatively, the maximum roughness may have an average peak-to-valley height, Rz, of 100 micrometers, 90 micrometers, 80 micrometers, 70 micrometers, 60 micrometers, 50 micrometers, 40 micrometers, 30 micrometers, 25 micrometers, 20 micrometers, 18 micrometers, 16 micrometers, 15 micrometers, 14 micrometers, 13 micrometers, 12 micrometers, 11 micrometers, or 10 micrometers.

Roughened tool surface 120 may be formed and/or defined in any suitable manner. In addition, roughened tool surface 120 may be roughened in a random manner and/or in a systematic manner. As an example, roughened tool surface 120 may be roughened such that a plurality of randomly located peaks and valleys extends thereacross. As another example, roughened tool surface 120 may be roughened such that a plurality of systematically and/or randomly located trenches, channels, and/or scratches extends thereacross. As yet another example, roughened tool surface 120 may include a plurality of roughened regions. The plurality of roughened regions may be proximal to and/or overlapping with one another. Additionally or alternatively, the roughened regions may be spaced apart from one another. As an example, each of the plurality of roughened regions may be proximal to and/or may surround a respective perforation 130.

As a more specific example, roughened tool surface 120 may be formed by abrading tool body 110. Under these conditions, roughened tool surface 120 also may be referred to herein as an abraded surface 120. As another example, roughened tool surface 120 may be formed by grit blasting tool body 110. Under these conditions, roughened tool surface 120 also may be referred to herein as a grit blasted surface 120. As yet another example, roughened tool surface 120 may be formed by sanding tool body 110. Under these conditions, roughened tool surface 120 also may be referred to herein as a sanded surface 120. As another example, roughened tool surface 120 may be formed by knurling tool body 110. Under these conditions, roughened tool surface 120 also may be referred to herein as a knurled surface 120. As yet another example, roughened tool surface 120 may be formed by patterning tool body 110. Under these conditions, roughened tool surface 120 also may be referred to herein as a patterned surface 120. As another example, roughened tool surface 120 may be formed by lithographically patterning tool body 110. Under these conditions, roughened tool surface 120 also may be referred to herein as a lithographically patterned surface 120. As yet another example, roughened tool surface 120 may be formed by etching tool body 110. Under these conditions, roughened tool surface 120 also may be referred to herein as an etched surface 120. As another example, roughened tool surface 120 may be formed by chemically etching tool body 110. Under these conditions, roughened tool surface 120 also may be referred to herein as a chemically etched surface 120. As yet another example, roughened tool surface 120 may be formed by laser etching tool body 110. Under these conditions, roughened tool surface 120 also may be referred to herein as a laser etched surface 120.

Tool 100, tool body 110, and/or roughened tool surface 120 may include, have, and/or define any suitable shape. As an example, roughened tool surface 120 may include, or be, a planar, or at least substantially planar, roughened tool surface 120. As another example, roughened tool surface 120 may define a surface contour (i.e., be non-linear) in two, or in only two, dimensions. As yet another example, roughened tool surface 120 may define a surface contour in three dimensions. As more specific examples, roughened tool surface 120 may have a shape that corresponds to and/or may be shaped to form thermoset composite layup 30 into one or more of a stringer of a composite aircraft, a skin of a composite aircraft, at least a portion of a wing of a composite aircraft, and/or at least a portion of a fuselage barrel of a composite aircraft.

Tool 100, tool body 110, and/or roughened tool surface 120 may include, have, and/or define any suitable size and/or extent. As an example, roughened tool surface 120 may define a maximum extent (or length) of at least 1 meter (m), at least 2 m, at least 3 m, at least 5 m, at least 10 m, at least 15 m, at least 20 m, at least 25 m, at least 30 m, at least 35 m, at least 40 m, at least 45 m, and/or at least 50 m. Additionally or alternatively, the maximum extent of roughened tool surface 120 may be less than 100 m, less than 90 m, less than 80 m, less than 70 m, less than 60 m, less than 50 m, less than 40 m, less than 30 m, less than 25 m, less than 20 m, less than 15 m, and/or less than 10 m.

As another example, roughened tool surface 120 may have a surface area of at least 0.5 square meters, at least 1 square meters, at least 2 square meters, at least 3 square meters, at least 4 square meters, at least 5 square meters, at least 6 square meters, at least 7 square meters, at least 8 square meters, at least 9 square meters, at least 10 square meters, at least 15 square meters, and/or at least 20 square meters. Additionally or alternatively, the surface area of roughened tool surface 120 may be less than 100 square meters, less than 90 square meters, less than 80 square meters, less than 70 square meters, less than 60 square meters, less than 50 square meters, less than 40 square meters, less than 30 square meters, less than 20 square meters, less than 10 square meters, and/or less than 5 square meters.

As discussed, tool 100, tool body 110, and/or roughened tool surface 120 may include and/or define the plurality of perforations 130. Perforations 130 may define an average distance between a given one of the plurality of perforations 130 and a closest other of the plurality of perforations 130. Examples of the average distance include average distances of at least 1 centimeter (cm), at least 2 cm, at least 3 cm, at least 4 cm, at least 5 cm, at least 6 cm, at least 7 cm, at least 8 cm, at least 9 cm, and/or at least 10 cm. Additionally or alternatively, the average distance also may be less than 20 cm, less than 18 cm, less than 16 cm, less than 14 cm, less than 12 cm, less than 10 cm, less than 9 cm, less than 8 cm, less than 7 cm, less than 6 cm, and/or less than 5 cm.

Tool 100 may include and/or be any suitable structure that may include tool body 110, that may define roughened tool surface 120, that may be configured to receive and/or support initial layer 40, and/or that may be configured to receive and/or support the plurality of plies 28 of thermoset composite material that define thermoset composite layup 30. As examples, tool 100 may include and/or be a layup mandrel, an inner mold line layup mandrel, and/or an outer mold line layup mandrel.

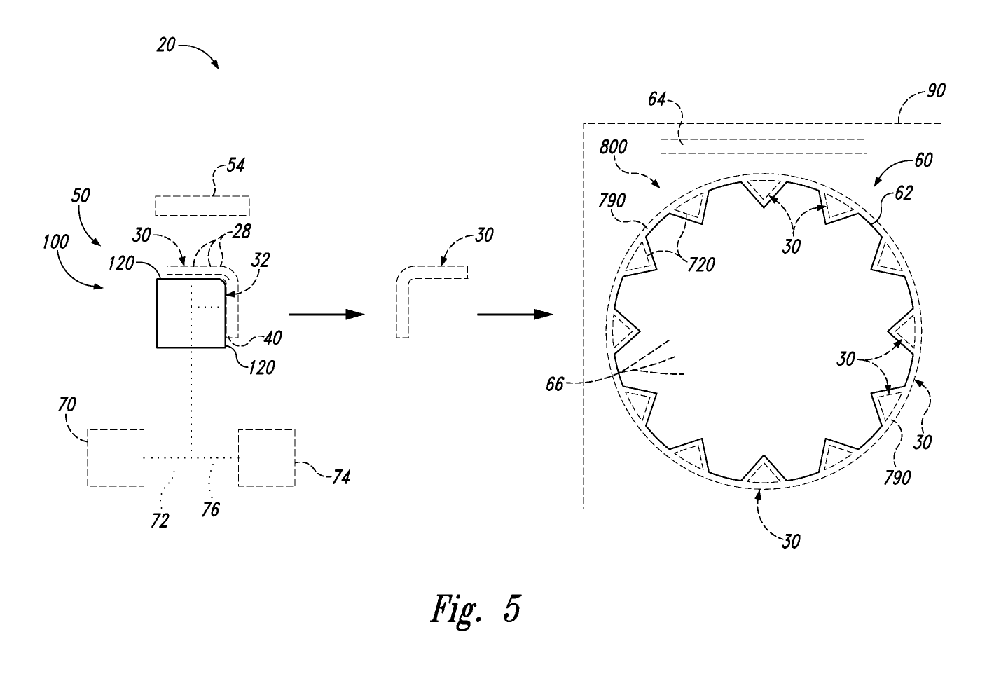

FIG. 5 is a schematic view of a system 20, according to the present disclosure, for forming a thermoset composite structure 800. System 20 includes a first tool 50 and a second tool 60. First tool 50 includes, or is, tool 100 of FIGS. 3-4, and any of the structures, functions, and/or features of tool 100 of FIGS. 3-4 may be included in and/or utilized with first tool 50 of FIG. 5 without departing from the scope of the present disclosure. First tool 50 is configured to receive a plurality of plies 28 of thermoset composite material on a roughened tool surface 120 thereof such that the plurality of plies 28 of composite material defines a thermoset composite layup 30. Second tool 60 defines a second tool surface 62 that is configured to receive a plurality of discrete thermoset composite layups 30. In addition, second tool 60 is configured to be heated with the plurality of discrete thermoset composite layups 30 to cure the plurality of discrete thermoset composite layups 30 and to define thermoset composite structure 800.

During operation of system 20, an initial layer 40 of material may be located on roughened tool surface 120 of first tool 50. In addition, a retention vacuum 72 may be applied, such as via a vacuum source 70, to an interface 32 between initial layer 40 and roughened tool surface 120. This may include application of the retention vacuum through and/or via one or more fluid manifolds 140 and/or perforations 130, which are discussed in more detail herein with reference to FIGS. 3-4.

Subsequently, a plurality of plies 28 of thermoset composite material may be located on initial layer 40, may be located on first tool 50, and/or may be supported by roughened tool surface 120 of first tool 50 to define a thermoset composite layup 30. During and/or subsequent to formation of thermoset composite layup 30, plies 28 may be compacted onto roughened tool surface 120 utilizing a first compaction device 54.

After formation thereof, thermoset composite layup 30 may be removed and/or separated from roughened tool surface 120 of first tool 50 prior to curing of thermoset composite layup 30, and first tool 50 may be configured to permit and/or facilitate this separation. As an example, and as discussed, the presence of roughened tool surface 120 may decrease a force needed to separate thermoset composite layup 30 from roughened tool surface 120. As another example, a fluid pressure 76 may be applied, such as via a fluid pressure source 74, to interface 32. This may include application of the fluid pressure through and/or via one or more fluid manifolds 140 and/or perforations 130, as discussed in more detail herein with reference to FIGS. 3-4, and may provide a motive force for separation of initial layer 40 from roughened tool surface 120. The separation may include separation of thermoset composite layup 30 from roughened tool surface 120 prior to receipt of thermoset composite layup 30 by second tool surface 62 of second tool 60.

Subsequently, thermoset composite layup 30 may be located, placed, and/or received on second tool surface 62 of second tool 60. In addition, and as illustrated, a plurality of discrete thermoset composite layups 30 also may be located, placed, and/or received on second tool surface 62. The plurality of discrete thermoset composite layups 30 may be placed on second tool surface 62 while in an uncured state and/or prior to being cured. During and/or subsequent to the plurality of discrete thermoset composite layups 30 being received on second tool surface 62, one or more of the plurality of discrete thermoset composite layups 30 may be compacted together and/or onto second tool surface 62, such as via utilizing a second compaction device 64.

After the plurality of discrete thermoset composite layups 30 has been located on second tool surface 62, the plurality of discrete thermoset composite layups 30 may receive further processing. As an example, additional plies of composite material may be added to, supported by, and/or compacted on second tool surface 62. As another example, the plurality of discrete thermoset composite layups 30 may be heated, such as via a heating assembly 90. This may include heating on second tool surface 62 and/or on another tool surface that is different from second tool surface 62. This heating may cure the plurality of discrete thermoset composite layups 30, thereby forming thermoset composite structure 800, which may be located on second tool surface 62. Subsequently, thermoset composite structure 800 may be separated from second tool 60 and/or removed from second tool surface 62, and second tool 60 may be configured to facilitate this separation. As an example, second tool 60 may include a plurality of sections 66 and/or portions 66 that may be separated from one another to facilitate separation of thermoset composite structure 800 therefrom.

First compaction device 54 and/or second compaction device 64 may include and/or be any suitable structure that may be adapted, configured, designed, and/or constructed to compact thermoset composite layup 30 on roughened tool surface 120 and/or to compact the plurality of discrete thermoset composite layups 30 on second tool surface 62, respectively. Examples of first compaction device 54 and/or of second compaction device 64 include any suitable vacuum compaction device, vacuum bag, vacuum chuck, pneumatic compaction device, hydraulic compaction device, and/or mechanical compaction device.

As discussed, vacuum source 70 may be configured to apply retention vacuum 72 to roughened tool surface 120 and/or to interface 32 between roughened tool surface 120 and initial layer 40. As an example, vacuum source 70 may be in selective fluid communication with perforations 130 via fluid manifold 140 (as illustrated in FIGS. 2-3). Under these conditions, vacuum source 70 may be configured to selectively apply retention vacuum 72 to roughened tool surface 120 via the plurality of perforations 130.

As also discussed, fluid pressure source 74 may be configured to apply fluid pressure 76 to roughened tool surface 120 and/or to interface 32 between roughened tool surface 120 and initial layer 40. As an example, fluid pressure source 74 may be in selective fluid communication with perforations 130 via fluid manifold 140 (as illustrated in FIG. 5). Under these conditions, fluid pressure source 74 may be configured to selectively apply fluid pressure 76 to roughened tool surface 120 via the plurality of perforations 130.

Initial layer 40 may include and/or be any suitable layer of material that may be located on and/or placed into contact with roughened tool surface 120 during formation of thermoset composite layup 30. As an example, initial layer 40 may include and/or be an initial ply 28 of thermoset composite material. As another example, initial layer 40 additionally or alternatively may include and/or be an intermediate layer that extends between the plurality of plies 28 and roughened tool surface 120. Examples of the intermediate layer include a release film that is configured to facilitate separation of thermoset composite layup 30 from roughened tool surface 120, an isolation film that is configured to prevent, or restrict, direct physical contact between thermoset composite layup 30 and roughened tool surface 120, a low surface energy material, a fluorinated polymer film, a smooth intermediate layer, an at least substantially smooth intermediate layer, and/or a textured intermediate layer.

Heating assembly 90 may include and/or be any suitable structure that may be configured to heat second tool 60 and/or the plurality of discrete thermoset composite layups 30 that may be received on second tool surface 62 of second tool 60. This may include heating second tool 60 and/or the plurality of discrete thermoset composite layups 30 to cure the plurality of discrete thermoset composite layups 30 and thereby form and/or define thermoset composite structure 800. Examples of heating assembly 90 include an oven and/or a heat lamp. As illustrated in FIG. 5, heat source 90 may be configured to house and/or contain second tool 60 and the plurality of discrete thermoset composite layups 30 during heating thereof; however, this is not required. Heat source 90 may not be configured to heat (or may not heat) first tool 50.

Generally, the plurality of discrete thermoset composite layups 30 includes thermoset composite layup 30 that was defined on first tool 50, as well as one or more additional thermoset composite layups 30 that may be defined on first tool 50 and/or on a different tool. The different tool may be similar to tool 100 of FIGS. 3-4; however, this is not required. Thus, and as illustrated, the plurality of discrete thermoset composite layups 30 may include and/or define a plurality of different shapes. As an example, and as illustrated in FIG. 5, the plurality of discrete thermoset composite layups 30 may define a plurality of stringers 770 and a plurality of skin segments 790; however, other shapes for the plurality of discrete thermoset composite layups are also within the scope of the present disclosure.

Thermoset composite layups 30 and/or plies 28 thereof may include and/or be formed from any suitable material and/or materials. As examples, plies 28 may include a fiberglass, a fiberglass cloth, a carbon fiber, a carbon fiber cloth, cloth, a pre-impregnated (pre-preg) composite material, a resin material, and/or an epoxy.

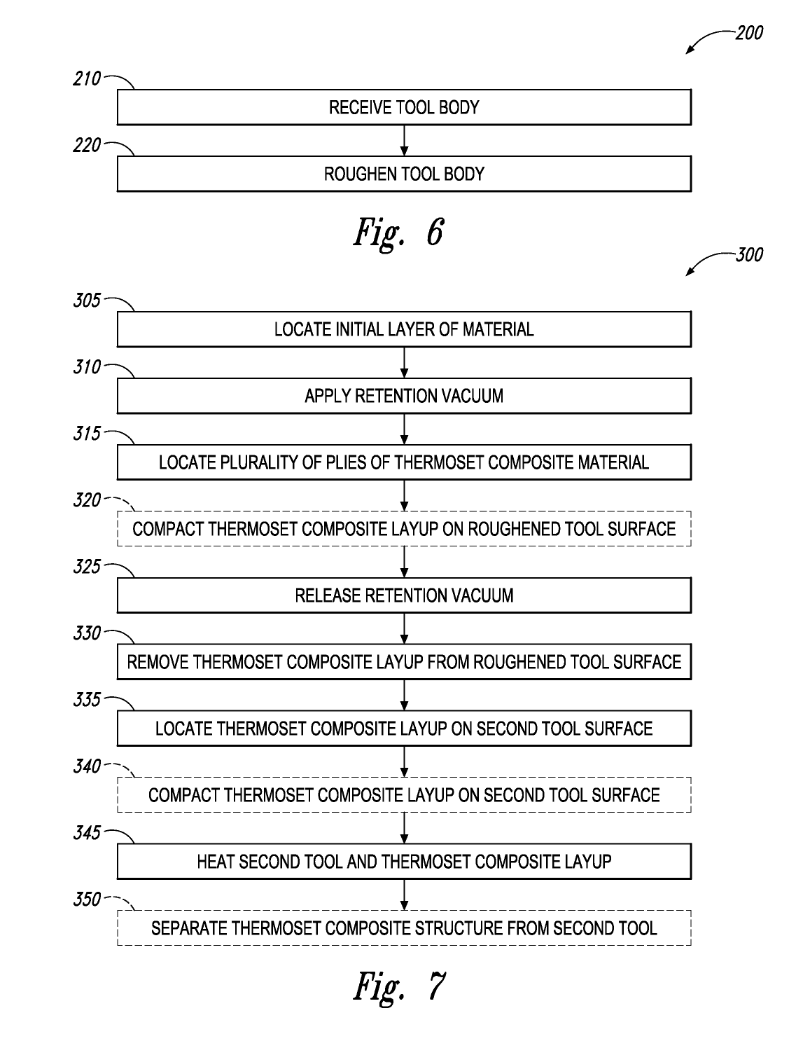

FIG. 6 is a flowchart depicting a method 200, according to the present disclosure, of forming a roughened tool surface on a tool body of a tool for receiving and forming a thermoset composite layup. Methods 200 include receiving the tool body at 210 and roughening the tool body at 220.

Receiving the tool body at 210 may include obtaining and/or procuring the tool body in any suitable manner. As examples, the receiving at 210 may include purchasing the tool body, fabricating the tool body, machining the tool body, obtaining the tool body, and/or locating the tool body in a work area where the roughening at 220 is to be performed.

Roughening the tool body at 220 may include roughening the tool body such that a roughness of the roughened tool surface is within a predefined roughness range. Examples of the predefined roughness range are discussed herein.

The roughening at 220 may include roughening in any suitable manner. As examples, the roughening at 220 may include abrading the tool body, grit blasting the tool body, sanding the tool body, knurling the tool body, patterning the tool body, lithographically patterning the tool body, etching the tool body, chemically etching the tool body, and/or laser etching the tool body.

It is within the scope of the present disclosure that the roughening at 220 may include randomly roughening the tool body. Additionally or alternatively, it is also within the scope of the present disclosure that the roughening at 220 may include systematically, or selectively, patterning the tool body. As an example, the roughening at 220 may include creating one or more roughened regions on the tool body. The roughened regions may be proximal to and/or overlapping with one another. Additionally or alternatively, the roughened regions also may be spaced apart from one another. Regardless of the exact mechanism, the roughening at 220 may include creating a network of interconnected fluid flow pathways that is at least partially defined by the tool body.

FIG. 7 is a flowchart depicting methods 300, according to the present disclosure, of forming a thermoset composite structure. Methods 300 include locating an initial layer of material on a roughened tool surface at 305, applying a retention vacuum at 310, and locating a plurality of plies of thermoset composite material at 315. Methods 300 further may include compacting a thermoset composite layup on the roughened tool surface at 320 and include releasing the retention vacuum at 325, removing the thermoset composite layup from the roughened tool surface at 330, and locating the thermoset composite layup on a second tool surface of a second tool at 335. Methods 300 further may include compacting the thermoset composite layup on the second tool surface at 340 and include heating the second tool and the thermoset composite layup at 345. Methods 300 also may include separating a thermoset composite structure from the second tool at 350.

Locating the initial layer of material on the roughened tool surface at 305 may include locating any suitable initial layer of material on the roughened tool surface. Examples of the initial layer of material are disclosed herein with reference to initial layer 40 of FIGS. 3-5.

The roughened tool surface may be defined by a tool body of a first tool, and the first tool may be different from, separate from, and/or spaced apart from the second tool. The roughened tool surface may include a plurality of perforations that may be configured to provide fluid communication between the roughened tool surface (or an interface between the roughened tool surface and the initial layer) and a fluid manifold. The fluid manifold may be in fluid communication with the plurality of perforations and/or may be at least partially defined by the tool body. The first tool may include and/or be tool 100 of FIGS. 3-5 and/or first tool 50 of FIG. 5.

Applying the retention vacuum at 310 may include applying the retention vacuum to the fluid manifold to retain the initial layer of material on the roughened tool surface. Application of the retention vacuum may generate a pressure differential across the initial layer of material, which may produce a pressure force that may be directed to retain the initial layer of material on the roughened tool surface. As discussed in more detail herein, the roughened tool surface may improve distribution and/or uniformity of the vacuum at the interface between the initial layer of material and the roughened tool surface.

Locating the plurality of plies of thermoset composite material at 315 may include locating the plurality of plies of thermoset composite material on the initial layer to define the thermoset composite layup. Additionally or alternatively, the locating at 315 also may be referred to herein as locating and/or receiving the plurality of plies of thermoset composite material on the roughened tool surface of the first tool. This may include sequentially, successively, consecutively, and/or serially locating the plurality of plies of thermoset composite material, one on top of the other, to form and/or define a layered stack of thermoset composite material that defines the thermoset composite layup. Examples of the plies of thermoset composite material are discussed herein with reference to plies 28 of FIGS. 3-5. Examples of thermoset composite layup 30 are discussed herein with reference to thermoset composite layup 30 of FIGS. 3-5.

Compacting the thermoset composite layup on the roughened tool surface at 320 may include compacting one or more plies of thermoset composite material that define the thermoset composite layup in any suitable manner. As an example, the compacting at 320 may include vacuum compacting the thermoset composite layup on the roughened tool surface. As another example, the compacting at 320 may include applying a compaction force to the thermoset composite layup utilizing any suitable compaction device. Examples of the compaction device are discussed herein with reference to first compaction device 54 of FIG. 5.

Regardless of the exact mechanism utilized, the compacting at 320 may include at least partially adhering the plurality of plies of thermoset composite material to one another, decreasing a spacing between adjacent plies of the plurality of plies of thermoset composite material, and/or removing a void space from within the thermoset composite layup. The compacting at 320 may be performed at any suitable time and/or with any suitable sequence during methods 300. As examples, the compacting at 320 may be performed subsequent to the locating at 305, subsequent to the applying at 310, subsequent to the locating at 315, during the locating at 315, and/or prior to the releasing at 325. When the compacting at 320 is performed during the locating at 315, methods 300 may include locating a first portion of the plurality of plies of thermoset composite material on the initial layer, compacting the first portion of the plurality of plies of thermoset composite material, and subsequently locating a second portion of the plurality of plies of thermoset composite material on the first portion of the plurality of plies of thermoset composite material. This process may be repeated any suitable number of times during methods 300.

Releasing the retention vacuum at 325 may include ceasing the applying at 310. Subsequent to the releasing at 325, the retention vacuum may dissipate, thereby decreasing (or eliminating) the pressure differential across the initial layer of material and decreasing (or eliminating) the pressure force that retains the initial layer of material on the roughened tool surface. In the systems and methods disclosed herein, and subsequent to the releasing at 325, the roughened tool surface may permit, facilitate, and/or speed air flow to the interface between the initial layer and the roughened tool surface, thereby permitting, facilitating, and/or speeding the removing at 330.

Removing the thermoset composite layup from the roughened tool surface at 330 may include separating the thermoset composite layup from the first tool. This may permit and/or facilitate the thermoset composite layup to be transferred to, received on, and/or located on the second tool surface of the second tool during the locating at 335. The removing at 330 may be accomplished in any suitable manner. As an example, the removing at 330 may include permitting atmospheric air to enter the interface between the initial layer and the roughened tool surface. As another example, the removing at 330 may include applying a fluid pressure to the roughened tool surface (or to the interface), such as via the fluid manifold and/or the plurality of perforations, to provide and/or generate a motive force for separation of the initial layer of material from the roughened tool surface.

Locating the thermoset composite layup on the second tool surface of the second tool at 335 may include locating the thermoset composite layup on the second tool surface prior to, to permit, and/or to facilitate further processing. As an example, methods 300 further may include locating additional plies of composite material and/or additional thermoset composite layup(s) on the second tool surface of the second tool. As another example, the locating at 335 may include locating prior to, to permit, and/or to facilitate, the heating at 345.

It is within the scope of the present disclosure that the locating at 335 and/or the further processing may include locating a plurality of discrete thermoset composite layups on the second tool surface of the second tool. The plurality of discrete thermoset composite layups may include the thermoset composite layup that was removed from the roughened tool surface during the removing at 330 as well as one or more additional, separate, and/or distinct thermoset composite layups. The one or more additional, separate, and/or distinct thermoset composite layups may be formed on the roughened tool surface of the first tool, such as via repeating the locating at 305, the applying at 310, the locating at 315, the releasing at 325, and the removing at 330. Additionally or alternatively, the one or more additional, separate, and/or distinct thermoset composite layups may be formed in another manner and/or utilizing a different tool. Examples of shapes of the plurality of discrete thermoset composite layups are disclosed herein.

Compacting the thermoset composite layup on the second tool surface at 340 may include compacting the thermoset composite layup, or the plurality of discrete thermoset composite layups, in any suitable manner. As an example, the compacting at 340 may include vacuum compacting the thermoset composite layup on the second tool surface. As another example, the compacting at 340 may include applying a compaction force to the thermoset composite layup utilizing any suitable compaction device. Examples of the compaction device are discussed herein with reference to second compaction device 64 of FIG. 5.

Regardless of the exact mechanism utilized, the compacting at 340 may include at least partially adhering the thermoset composite layup to the second tool surface and/or to another thermoset composite layup that may be present on the second tool surface and/or in contact with the thermoset composite layup. The compacting at 340 may be performed at any suitable time and/or with any suitable sequence during methods 300. As examples, the compacting at 340 may be performed subsequent to the locating at 305, subsequent to the applying at 310, subsequent to the locating at 315, subsequent to the releasing at 325, subsequent to the removing at 330, subsequent to the locating at 335, prior to the heating at 345, and/or prior to the separating at 350.

Heating the second tool and the thermoset composite layup at 345 may include heating to cure the thermoset composite layup and/or to define the thermoset composite structure. When the locating at 335 includes locating the plurality of discrete thermoset composite layups on the second tool surface, the heating at 345 may include heating, or heating all of, the plurality of discrete thermoset composite layups.

Separating the thermoset composite structure from the second tool at 350 may include separating to permit and/or facilitate use, utilization, operation, and/or further processing of the thermoset composite structure. The separating at 350 may be performed at any suitable time and/or with any suitable sequence during methods 300. As an example, the separating at 350 may be performed subsequent to the heating at 345.

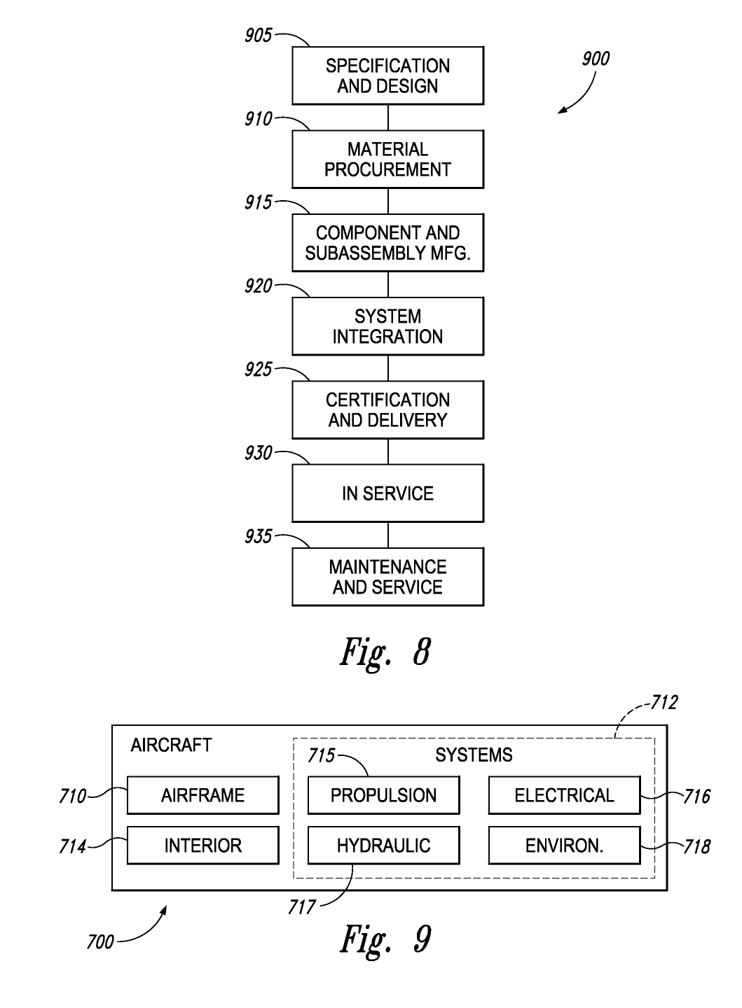

Referring now to FIGS. 8-9, embodiments of the disclosure may be described in the context of an aircraft manufacturing and service method 900, as shown in FIG. 8, and/or an aircraft 700, as shown in FIG. 9. During pre-production, exemplary method 900 may include specification and design 905 of the aircraft 700 and material procurement 910. During production, component and subassembly manufacturing 915 and system integration 920 of the aircraft 700 take place. Thereafter, the aircraft 700 may go through certification and delivery 925 in order to be placed in service 930. While in service by a customer, the aircraft 700 is scheduled for routine maintenance and service 935 (which also may include modification, reconfiguration, refurbishment, and so on).

Each of the processes of method 900 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 9, aircraft 700 produced by exemplary method 900 may include an airframe 710 with a plurality of systems 712 and an interior 714. Examples of high-level systems 712 include one or more of a propulsion system 715, an electrical system 716, a hydraulic system 717, and an environmental system 718. Any number of other systems may be included. Although an aerospace example is shown, the principles of the invention may be applied to other industries, such as the automotive industry.

System and methods embodied herein may be employed during any one or more of the stages of the manufacturing and service method 900. For example, components or subassemblies corresponding to component and subassembly manufacturing process 915 may be fabricated or manufactured in a manner similar to components or subassemblies produced while the aircraft 700 is in service. Also, one or more system embodiments, method embodiments, or a combination thereof may be utilized during the production stages 915 and 920, for example, by substantially expediting assembly of or reducing the cost of an aircraft 700. Similarly, one or more of system embodiments, method embodiments, or a combination thereof may be utilized while the aircraft 700 is in service, for example and without limitation, to maintenance and service 935.

Examples of inventive subject matter according to the present disclosure are described in the following enumerated paragraphs:

A1. A tool for receiving and forming a thermoset composite layup, the tool comprising:

a tool body that defines a roughened tool surface, wherein:

(i) the roughened tool surface is shaped to receive and to form a plurality of plies of thermoset composite material that defines the thermoset composite layup; and

(ii) a roughness of the roughened tool surface is within a predefined roughness range.

A2. The tool of paragraph A1, wherein the predefined roughness range extends between a minimum roughness and a maximum roughness.

A3. The tool of paragraph A2, wherein the minimum roughness has an average peak-to-valley height, Rz, as defined by ASME Y14.36M-1996, of 5 micrometers, 6 micrometers, 7 micrometers, 8 micrometers, 9 micrometers, 10 micrometers, 11 micrometers, 12 micrometers, 13 micrometers, 14 micrometers, 15 micrometers, 16 micrometers, 17 micrometers, 18 micrometers, 19 micrometers, or 20 micrometers.

A4. The tool of any of paragraphs A2-A3, wherein the maximum roughness has an average peak-to-valley height, Rz, as defined by ASME Y14.36M-1996, of 100 micrometers, 90 micrometers, 80 micrometers, 70 micrometers, 60 micrometers, 50 micrometers, 40 micrometers, 30 micrometers, 25 micrometers, 20 micrometers, 18 micrometers, 16 micrometers, 15 micrometers, 14 micrometers, 13 micrometers, 12 micrometers, 11 micrometers, or 10 micrometers.

A5. The tool of any of paragraphs A1-A4, wherein the roughened tool surface includes at least one of:

(i) an abraded surface;

(ii) a grit blasted surface;

(iii) a sanded surface;

(iv) a knurled surface;

(v) a patterned surface;

(vi) a lithographically patterned surface;

(vii) an etched surface;

(viii) a chemically etched surface; and

(ix) a laser etched surface.

A6. The tool of any of paragraphs A1-A5, wherein the roughened tool surface further defines a plurality of perforations configured to provide fluid communication between the roughened tool surface and a fluid manifold that is in fluid communication with the plurality of perforations, optionally wherein the fluid manifold is at least partially defined by the tool body.

A7. The tool of paragraph A6, wherein the plurality of perforations defines an average distance between a given one of the plurality of perforations and a closest other of the plurality of perforations.

A8. The tool of paragraph A7, wherein the average distance is at least one of:

(i) at least 1 centimeter (cm), at least 2 cm, at least 3 cm, at least 4 cm, at least 5 cm, at least 6 cm, at least 7 cm, at least 8 cm, at least 9 cm, or at least 10 cm; and

(ii) less than 20 cm, less than 18 cm, less than 16 cm, less than 14 cm, less than 12 cm, less than 10 cm, less than 9 cm, less than 8 cm, less than 7 cm, less than 6 cm, or less than 5 cm.

A9. The tool of any of paragraphs A1-A8, wherein the tool is a layup mandrel.

A10. The tool of any of paragraphs A1-A9, wherein the tool is an inner mold line layup mandrel.

All. The tool of any of paragraphs A1-A10, wherein the tool is an outer mold line layup mandrel.

A12. The tool of any of paragraphs A1-A11, wherein the roughened tool surface is shaped to form the thermoset composite layup into one of:

(i) a stringer of a composite aircraft;

(ii) a skin of the composite aircraft;

(iii) at least a portion of a wing of the composite aircraft; and

(iv) at least a portion of a fuselage barrel of the composite aircraft.

A13. The tool of any of paragraphs A1-A12, wherein the roughened tool surface includes, and optionally is, a planar, or at least substantially planar, roughened tool surface.

A14. The tool of any of paragraphs A1-A13, wherein the roughened tool surface defines a surface contour in two, and optionally in only two, dimensions.

A15. The tool of any of paragraphs A1-A14, wherein the roughened tool surface defines a surface contour in three dimensions.

A16. The tool of any of paragraphs A1-A15, wherein the roughened tool surface defines a maximum extent of at least one of:

(i) at least 1 meter (m), at least 2 m, at least 3 m, at least 5 m, at least 10 m, at least 15 m, at least 20 m, at least 25 m, at least 30 m, at least 35 m, at least 40 m, at least 45 m, or at least 50 m; and

(ii) less than 100 m, less than 90 m, less than 80 m, less than 70 m, less than 60 m, less than 50 m, less than 40 m, less than 30 m, less than 25 m, less than 20 m, less than 15 m, or less than 10 m.

A17. The tool of any of paragraphs A1-A16, wherein the roughened tool surface has a surface area of at least one of:

(i) at least 0.5 square meters, at least 1 square meters, at least 2 square meters, at least 3 square meters, at least 4 square meters, at least 5 square meters, at least 6 square meters, at least 7 square meters, at least 8 square meters, at least 9 square meters, at least 10 square meters, at least 15 square meters, or at least 20 square meters; and

(ii) less than 100 square meters, less than 90 square meters, less than 80 square meters, less than 70 square meters, less than 60 square meters, less than 50 square meters, less than 40 square meters, less than 30 square meters, less than 20 square meters, less than 10 square meters, or less than 5 square meters.

B1. A system for forming a thermoset composite structure, the system comprising:

a first tool that includes the tool of any of paragraphs A1-A17, wherein the first tool is configured to receive a plurality of plies of thermoset composite material on the roughened tool surface, and further wherein the plurality of plies of thermoset composite material defines a thermoset composite layup; and

a second tool that defines a second tool surface configured to receive a plurality of discrete thermoset composite layups, which includes the thermoset composite layup, wherein the second tool further is configured to be heated with the plurality of discrete thermoset composite layups to cure the plurality of discrete thermoset composite layups and define the thermoset composite structure.

B2. The system of paragraph B1, wherein the second tool is configured to facilitate separation of the thermoset composite structure therefrom, optionally subsequent to the second tool being heated with the plurality of discrete thermoset composite layups.

B3. The system of any of paragraphs B1-B2, wherein the first tool is configured to facilitate separation of the thermoset composite layup from the roughened tool surface prior to curing of the thermoset composite layup, and optionally prior to receipt of the thermoset composite layup by the second tool surface of the second tool.

B4. The system of any of paragraphs B1-B3, wherein the system further includes a vacuum source.

B5. The system of paragraph B4, wherein the vacuum source is in selective fluid communication with a/the fluid manifold that is in fluid communication with a/the plurality of perforations that is defined by the roughened tool surface, and further wherein the vacuum source is configured to selectively apply a retention vacuum to the roughened tool surface via the plurality of perforations, and optionally wherein the fluid manifold is at least partially defined by the tool body.

B6. The system of paragraph B5, wherein the retention vacuum is configured to selectively retain an initial layer of material on the roughened tool surface, optionally wherein the initial layer of material includes at least one of (i) an initial ply of thermoset composite material and (ii) an intermediate layer that extends between the plurality of plies of thermoset composite material and the roughened tool surface.

B7. The system of any of paragraphs B1-B6, wherein the system further includes a fluid pressure source.

B8. The system of paragraph B7, wherein the fluid pressure source is in selective fluid communication with a/the fluid manifold that is in fluid communication with a/the plurality of perforations that is defined by the roughened tool surface, and further wherein the fluid pressure source is configured to selectively apply a fluid pressure to the roughened tool surface via the plurality of perforations, and optionally wherein the fluid manifold is at least partially defined by the tool body.

B9. The system of paragraph B8, wherein the fluid pressure source is configured to selectively provide a motive force for separation of an/the initial layer of material from the roughened tool surface, optionally wherein the initial layer of material includes at least one of (i) an/the initial ply of thermoset composite material and (ii) an/the intermediate layer that extends between the plurality of plies of thermoset composite material and the roughened tool surface.

B10. The system of any of paragraphs B1-B9, wherein the system includes the thermoset composite layup.

B11. The system of paragraph B10, wherein the thermoset composite layup is located on the roughened tool surface of the first tool.

B12. The system of any of paragraphs B10-B11, wherein the thermoset composite layup has been separated from the roughened tool surface of the first tool.

B13. The system of any of paragraphs B10-B12, wherein the thermoset composite layup is received on the second tool surface of the second tool.

B14. The system of any of paragraphs B1-B13, wherein the system includes the plurality of discrete thermoset composite layups.

B15. The system of paragraph B14, wherein the plurality of discrete thermoset composite layups is located on the second tool surface.

B16. The system of any of paragraphs B14-B15, wherein the plurality of discrete thermoset composite layups is uncured.

B17. The system of any of paragraphs B1-B16, wherein the system includes the thermoset composite structure.

B18. The system of paragraph B17, wherein the thermoset composite structure is located on the second tool surface.

B19. The system of any of paragraphs B1-B18, wherein the system further includes an/the intermediate layer that is located between the roughened tool surface and the thermoset composite layup.

B20. The system of paragraph B19, wherein the intermediate layer includes a release film configured to facilitate separation of the thermoset composite layup from the roughened tool surface.

B21. The system of any of paragraphs B19-B20, wherein the intermediate layer includes an isolation film configured to prevent direct physical contact between the thermoset composite layup and the roughened tool surface.

B22. The system of any of paragraphs B19-B21, wherein the intermediate layer includes a low surface energy material.

B23. The system of any of paragraphs B19-B22, wherein the intermediate layer includes a fluorinated polymer film.

B24. The system of any of paragraphs B19-B23, wherein the intermediate layer is a smooth, or at least substantially smooth, intermediate layer.

B25. The system of any of paragraphs B19-B23, wherein the intermediate layer is a textured intermediate layer.

B26. The system of any of paragraphs B1-B25, wherein the system further includes a compaction device.

B27. The system of paragraph B26, wherein the compaction device is configured to compact the plurality of plies of thermoset composite material on the roughened tool surface.

B28. The system of any of paragraphs B26-B27, wherein the compaction device is configured to compact the plurality of discrete thermoset composite layups on the second tool surface.

B29. The system of any of paragraphs B26-B28, wherein the compaction device includes at least one of (i) a vacuum bag and (ii) a vacuum chuck.

B30. The system of any of paragraphs B1-B29, wherein the system further includes a heating assembly configured to heat the second tool and the plurality of discrete thermoset composite layups to cure the plurality of discrete thermoset composite layups and define the thermoset composite structure.

B31. The system of paragraph B30, wherein the second tool and the plurality of discrete thermoset composite layups are being heated by the heating assembly.

B32. The system of any of paragraphs B30-B31, wherein the first tool is not being heated by the heating assembly.

C1. A method of forming a roughened tool surface on a tool body of a tool for receiving and forming a thermoset composite layup, the method comprising:

receiving the tool body; and

roughening the tool body such that a roughness of the roughened tool surface is within a predefined roughness range.

C2. The method of paragraph C1, wherein the roughening includes at least one of:

(i) abrading the tool body;

(ii) grit blasting the tool body;

(iii) sanding the tool body;

(iv) knurling the tool body;

(v) patterning the tool body;

(vi) lithographically patterning the tool body;

(vii) etching the tool body;

(viii) chemically etching the tool body; and

(ix) laser etching the tool body

C3. The method of any of paragraphs C1-C2, wherein the roughening includes randomly roughening the tool body.

C4. The method of any of paragraphs C1-C3, wherein the roughening includes systematically patterning the tool body.

C5. The method of any of paragraphs C1-C4, wherein the roughening includes creating a network of interconnected fluid flow pathways that is at least partially defined by the tool body.

C6. The method of any of paragraphs C1-05, wherein the tool includes the tool of any of paragraphs A1-A17.

D1. A method of forming a thermoset composite structure, the method comprising:

locating an initial layer of material on a roughened tool surface of a first tool, wherein the first tool includes a tool body that defines the roughened tool surface, and further wherein the roughened tool surface includes a plurality of perforations configured to provide fluid communication between the roughened tool surface and a fluid manifold that is in fluid communication with the plurality of perforations and optionally that is at least partially defined by the tool body;

applying a retention vacuum to the fluid manifold to retain the initial layer of material on the roughened tool surface;

locating a plurality of plies of thermoset composite material on the initial layer of material to define a thermoset composite layup;

releasing the retention vacuum;

removing the thermoset composite layup from the roughened tool surface of the first tool;

locating the thermoset composite layup on a second tool surface of a second tool; and

performing additional processing on the thermoset composite layup while the thermoset composite layup is located on the second tool surface of the second tool, optionally wherein the performing additional processing on the thermoset composite layup includes heating the second tool and the thermoset composite layup to cure the thermoset composite layup and define the thermoset composite structure.

D2. The method of paragraph D1, wherein, prior to the heating, the locating the thermoset composite layup includes locating a plurality of discrete thermoset composite layups, which includes the thermoset composite layup, on the second tool surface of the second tool, wherein the heating includes heating the second tool and the plurality of discrete thermoset composite layups to cure the plurality of discrete thermoset composite layups and define the thermoset composite structure.

D3. The method of paragraph D2, wherein the plurality of discrete thermoset composite layups is shaped to define at least two of:

(i) a stringer of a composite aircraft;

(ii) a skin of the composite aircraft;

(iii) at least a portion of a wing of the composite aircraft; and

(iv) at least a portion of a fuselage barrel of the composite aircraft.

D4. The method of any of paragraphs D1-D3, wherein the removing includes applying a fluid pressure to the roughened tool surface via the plurality of perforations to provide a motive force for separation of the initial layer of material from the roughened tool surface.

D5. The method of any of paragraphs D1-D4, wherein, subsequent to the heating, the method further includes separating the thermoset composite structure from the second tool.

D6. The method of any of paragraphs D1-D5, wherein the initial layer includes an intermediate layer that is located between the roughened tool surface and the thermoset composite layup.

D7. The method of paragraph D6, wherein the intermediate layer includes a release film configured to facilitate separation of the thermoset composite layup from the roughened tool surface.

D8. The method of any of paragraphs D6-D7, wherein the intermediate layer includes an isolation film configured to prevent direct physical contact between the thermoset composite layup and the roughened tool surface.

D9. The method of any of paragraphs D6-D8, wherein the intermediate layer includes a low surface energy material.

D10. The method of any of paragraphs D6-D9, wherein the intermediate layer includes a fluorinated polymer film.

D11. The method of any of paragraphs D6-D10, wherein the intermediate layer is a smooth, or at least substantially smooth, intermediate layer.

D12. The method of any of paragraphs D6-D10, wherein the intermediate layer is a textured intermediate layer.

D13. The method of any of paragraphs D1-D12, wherein the initial layer includes an initial ply of thermoset composite material.

D14. The method of any of paragraphs D1-D13, wherein, prior to the releasing, the method further includes compacting the thermoset composite layup on the roughened tool surface.

D15. The method of any of paragraphs D1-D14, wherein, prior to the heating, the method further includes compacting the thermoset composite layup, and optionally a/the plurality of discrete thermoset composite layups, on the second tool surface.

D16. The method of any of paragraphs D1-D15, wherein the first tool includes the tool of any of paragraphs A1-A17.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

1. A system for forming a thermoset composite structure, the system comprising:
a first tool that includes a tool body that defines a roughened tool surface, wherein the roughened tool surface is shaped to receive and to form a plurality of plies of thermoset composite material, which defines a thermoset composite layup, and further wherein a roughness of the roughened tool surface is within a predefined roughness range; and
a second tool that defines a second tool surface configured to receive a plurality of discrete thermoset composite layups, which includes the thermoset composite layup, wherein the second tool further is configured to be heated with the plurality of discrete thermoset composite layups to cure the plurality of discrete thermoset composite layups and define the thermoset composite structure.

2. The system of claim 1, wherein the system further includes a vacuum source that is in selective fluid communication with a fluid manifold that is in fluid communication with a plurality of perforations that is defined by the roughened tool surface, and further wherein the vacuum source is configured to selectively apply a retention vacuum to the roughened tool surface via the plurality of perforations.

3. The system of claim 2, wherein the retention vacuum is configured to selectively retain an initial layer of material on the roughened tool surface.

4. The system of claim 1, wherein the system further includes a fluid pressure source that is in selective fluid communication with a fluid manifold that is in fluid communication with a plurality of perforations that is defined by the roughened tool surface, and further wherein the fluid pressure source is configured to selectively apply a fluid pressure to the roughened tool surface via the plurality of perforations.

5. The system of claim 4, wherein the fluid pressure source is configured to selectively provide a motive force for separation of an initial layer of material from the roughened tool surface.

6. The system of claim 1, wherein the system further includes an intermediate layer that is located between the roughened tool surface and the thermoset composite layup.

7. The system of claim 6, wherein the intermediate layer includes at least one of:
(i) a release film configured to facilitate separation of the thermoset composite layup from the roughened tool surface;
(ii) an isolation film configured to prevent direct physical contact between the thermoset composite layup and the roughened tool surface;
(iii) a low surface energy material;
(iv) a fluorinated polymer film;
(v) an at least substantially smooth intermediate layer; and
(vi) a textured intermediate layer.

8. The system of claim 1, wherein the system further includes a first compaction device configured to compact the plurality of plies of thermoset composite material on the roughened tool surface.

9. The system of claim 1, wherein the system further includes a second compaction device configured to compact the plurality of discrete thermoset composite layups on the second tool surface.

10. The system of claim 1, wherein the system further includes a heating assembly configured to heat the second tool and the plurality of discrete thermoset composite layups to cure the plurality of discrete thermoset composite layups and define the thermoset composite structure.

11. The system of claim 1, wherein the predefined roughness range extends between a minimum roughness and a maximum roughness, wherein the minimum roughness has an average peak-to-valley height of the minimum roughness of 8 micrometers, and further wherein the maximum roughness has an average peak-to-valley height of the maximum roughness of 100 micrometers.

12. The system of claim 1, wherein the roughened tool surface includes at least one of:
(i) an abraded surface;
(ii) a grit blasted surface;
(iii) a sanded surface;
(iv) a knurled surface;
(v) a patterned surface;
(vi) a lithographically patterned surface;
(vii) an etched surface;
(viii) a chemically etched surface; and
(ix) a laser etched surface.

13. The system of claim 1, wherein the first tool is a layup mandrel for the thermoset composite layup.

14. The system of claim 1, wherein the roughened tool surface is shaped to form the thermoset composite layup into one of:
(i) a stringer of a composite aircraft;
(ii) a skin of the composite aircraft;
(iii) at least a portion of a wing of the composite aircraft; and
(iv) at least a portion of a fuselage barrel of the composite aircraft.

15. The system of claim 1, wherein the roughened tool surface has a surface area of at least 4 square meters.

16. A method of forming a thermoset composite structure, the method comprising:
locating an initial layer of material on a roughened tool surface of a first tool, wherein the first tool includes a tool body that defines the roughened tool surface, and further wherein the roughened tool surface includes a plurality of perforations configured to provide fluid communication between the roughened tool surface and a fluid manifold that is in fluid communication with the plurality of perforations;
applying a retention vacuum to the fluid manifold to retain the initial layer of material on the roughened tool surface;
locating a plurality of plies of thermoset composite material on the initial layer of material to define a thermoset composite layup;
releasing the retention vacuum;
removing the thermoset composite layup from the roughened tool surface of the first tool;
locating the thermoset composite layup on a second tool surface of a second tool; and
performing additional processing on the thermoset composite layup while the thermoset composite layup is located on the second tool surface of the second tool.

17. The method of claim 16, wherein the performing additional processing includes heating the second tool and the thermoset composite layup to cure the thermoset composite layup and define the thermoset composite structure.

18. The method of claim 17, wherein, prior to the heating, the locating the thermoset composite layup includes locating a plurality of discrete thermoset composite layups, which includes the thermoset composite layup, on the second tool surface of the second tool, wherein the heating includes heating the second tool and the plurality of discrete thermoset composite layups to cure the plurality of discrete thermoset composite layups and define the thermoset composite structure.

19. The method of claim 18, wherein the plurality of discrete thermoset composite layups is shaped to define at least two of:
(i) a stringer of a composite aircraft;
(ii) a skin of the composite aircraft;
(iii) at least a portion of a wing of the composite aircraft; and
(iv) at least a portion of a fuselage barrel of the composite aircraft.

20. The method of claim 16, wherein the removing includes applying a fluid pressure to the roughened tool surface via the plurality of perforations to provide a motive force for separation of the initial layer of material from the roughened tool surface.

21. The method of claim 16, wherein, prior to the releasing, the method further includes compacting the thermoset composite layup on the roughened tool surface.
